(19) United States
(12) Patent Application Publication
(10) Pub. No.: US 2011/0237989 A1
(43) Pub. Date: Sep. 29, 2011

(54) Vibro-Acoustical Body Support

(76) Inventors: Rudy A. Vandenbelt, Ottawa (CA); Matthew T.R. Bailey, Ottawa (CA); Ross L. Cowie, Ottawa (CA)

(21) Appl. No.: 12/731,918

(22) Filed: Mar. 25, 2010

(51) Int. Cl. A61H 1/00

(52) U.S. Cl. 601/47; 601/49

(57) ABSTRACT

A vibro-acoustical body support includes sources of audio and of low-frequency vibrational energy carried by or coupled to a chassis. The source of audio preferably includes an MP3 player and stereo speakers and/or headphones. The source of low-frequency vibrational energy includes a resonating chamber having a resonant wall provided by a diaphragm and a low-frequency transducer attached to the diaphragm that freely extends into the resonating chamber. In one presently preferred and exemplary chair topper embodiment, the chassis has an orthopedic S-shape and the diaphragm is arranged as a back supporting resonant lumbar plate.

### FIELD OF THE INVENTION

This invention is drawn to the field of kinesotherapy, and more particularly, to an improved vibro-acoustical body support.

### BACKGROUND OF THE INVENTION

U.S. Pat. No. 5,101,810, issued Apr. 7, 1992 to Skille et al., incorporated herein by reference, discloses apparatus and method for therapeutic application of vibro-acoustical energy to the human body.

Skille's invention, variously embodied in specially designed chairs and beds, includes audio speakers for playing music, together with a low-frequency loudspeaker. The low-frequency loudspeaker, contained in a closed box built into the chair or bed, provides low-frequency vibrational energy directly through the air to the human body. The sounds of the audio speakers and the low-frequency vibrations of the loudspeaker act in combination on the user to provide vibro-acoustical therapy whose physical and psychical character depends on the parameters selected for the low-frequency vibrations and on the type of the audio sounds selected.

However, not only are Skille's specially designed chairs and beds costly, and comparatively difficult to manufacture, but the utility of Skille's low-frequency energy source is limited by the direct through air coupling of its low-frequency, closed box loudspeakers; the air attenuates the low-frequency energy. The utility of Skille's low-frequency energy source is also limited by the loudspeaker of its low-frequency, closed box loudspeakers. The larger the aperture size the larger the area treated but the greater the cost and the more difficult it is to integrate into chairs and bedding. An array of smaller diameter loudspeakers may be used, but the cost multiplies by the number of loudspeakers arrayed.

There is thus a need to provide an improved vibro-acoustical body support not subject to the disadvantages of the prior art.

### SUMMARY OF THE INVENTION

Accordingly, it is the principal object of the present invention to disclose an improved vibro-acoustical body support not subject to the disadvantages of the prior art.

The vibro-acoustical body support for providing vibro-acoustical therapy to a user of the present invention includes a chassis; an acoustic source coupled to the chassis arranged to transfer acoustic energy to the ears of the user; and a source of low-frequency vibrational energy carried by the chassis arranged to transfer low-frequency vibrational energy to the body of the user.

The source of low-frequency sound includes an open resonating chamber carried by the chassis, the open resonating chamber carried by the chassis includes an air cavity bounded by four (4) side walls and included back wall terminating in an open face opposite the back wall and confronting the user. A diaphragm forming a wall substantially closing the resonating chamber is attached to the open face of the resonating chamber carried by the chassis. A low-frequency transducer freely extending into the air cavity of the resonating chamber is attached to the diaphragm. A controller is coupled to the source of low-frequency vibrational energy. In response to user-input control selection, the low-frequency transducer attached to the backside of the diaphragm sets the diaphragm in cyclic to and fro motion and thereby couples low-frequency vibrational energy directly to the user though contact with the moving diaphragm.

The low-frequency transducer has an aperture size much smaller than that of the diaphragm. When the diaphragm is set in motion, it transfers energy directly to the user over an area much larger than the aperture size of the of the low-frequency transducer thereby providing low-frequency therapy at comparatively-low cost.

The controller is also coupled to the source of acoustic energy. In response to user-input control selection, the source of acoustic energy provides audible sounds concurrently with the low-frequency vibrational energy to provide different user-selected modes of vibro-acoustical therapy.

The principles of the present invention are applicable to a variety of body supports such as chairs and beds and may be incorporated into such body supports or usable therewith as removable accessories and/or may be used as vibro-acoustical shoulder massagers, hand-held massagers among others. In the presently preferred and illustrated embodiment, the chassis of the vibro-acoustical body support of the present invention is of slim profile taller and wider than it is thick that is arranged to function as a chair topper that fits on the seat-back of a chair.

In the presently preferred and exemplary chair topper embodiment of the vibro-acoustical body support of the present invention, the chassis advantageously is formed with an orthopedic S-shape. The diaphragm is advantageously arranged as a resonant back-supporting lumbar plate sized and shaped to conform to the back and sides between the ribs and pelvis of the user when seated on the seat-back on which the chair topper is removably positioned. The diaphragm shaped as a resonant back-supporting lumber plate delivers low-frequency vibrational energy directly to the whole lumber region of the user in contact therewith thereby massaging the user and/or obtain other therapeutic effects.

The sounds provided by the audio source may be streamed or prerecorded, the prerecorded sounds may be provided on internal and/or by external memory, and may be played through speakers and/or headphones. In the presently preferred and exemplary chair topper embodiment, the audio sounds are in MP3 format stored on internal memory and are grouped to provide user-selectable “sleep,” “relaxation,” “energization,” and “stress relief” sounds. The intensity of the low-frequency source may advantageously be adjusted by the user between predetermined minimum and maximum values. Advantageously and desirably, the control input for audio selection and for intensity of low-frequency vibrational energy conveniently is provided on a hand-held controller that may be stowed in the chair topper when not in use. Alternately, the controls may be built into the chair topper.

### BRIEF DESCRIPTION OF THE DRAWINGS

These and other objects, inventive aspects and advantageous features of the present invention will become apparent as the invention becomes better understood by referring to the following, solely exemplary, detailed description of the presently preferred embodiments, and to the drawings, wherein:

FIG. 1A is a front and side pictorial view of the vibro-acoustical chair topper with slim profile in accord with the present invention;

FIG. 1B is a pictorial view of the vibro-acoustical chair topper with slim profile in accord with the present invention, showing the chair topper in use on the seat-back of a chair;

FIG. 1C is a pictorial view of the vibro-acoustical chair topper with slim profile in accord with the present invention, showing the chair topper in use on a bed;

FIG. 2 is an exploded pictorial view of the front and side of the vibro-acoustical chair topper with slim profile in accord with the present invention, with its upholstery removed;

FIG. 3 is a pictorial view of the back of the vibro-acoustical chair topper with slim profile of the FIG. 2 in accord with the present invention;

FIG. 4 is a fragmentary, longitudinal sectional view through the resonating chamber of the vibro-acoustical chair topper with slim profile in accord with the present invention;

FIG. 5 is a functional block circuit diagram of the vibro-acoustical chair topper with slim profile in accord with the present invention; and

FIG. 6 shows a front view of the hand-held controller of the vibro-acoustical chair topper with slim profile in accord with the present invention.

### DETAILED DESCRIPTION OF THE PRESENTLY PREFERRED EMBODIMENTS

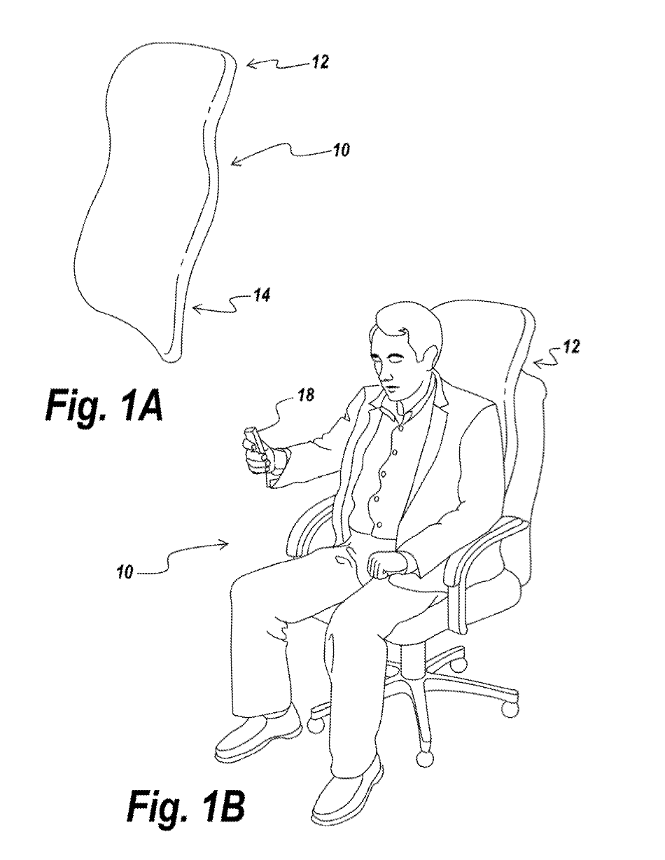

Referring now to FIGS. 1A, 1B and 1C, generally designated at 10 are pictorial views of a vibro-acoustical chair topper in accord with the present invention. The chair topper 10 has a slim profile taller and wider than it is thick by which it is adapted for removable placement between a user and a seat-back as illustrated in the FIGS. 1B, 1C.

The chair topper 10 includes an upper, head rest area generally designated 12 and a lower, back rest area generally designated 14. The upper, head rest area 12 is provided with a source of acoustic energy to be described and the lower, back rest area 14 of the chair topper 10 is provided with a source of low-frequency vibrational energy to be described. A hand-held controller 18 allows the user to listen to audio provided via the acoustic source and to concurrently experience vibrational energy provided via the source of low-frequency vibrational energy in various user settable and selectable vibro-acoustical modes to be described.

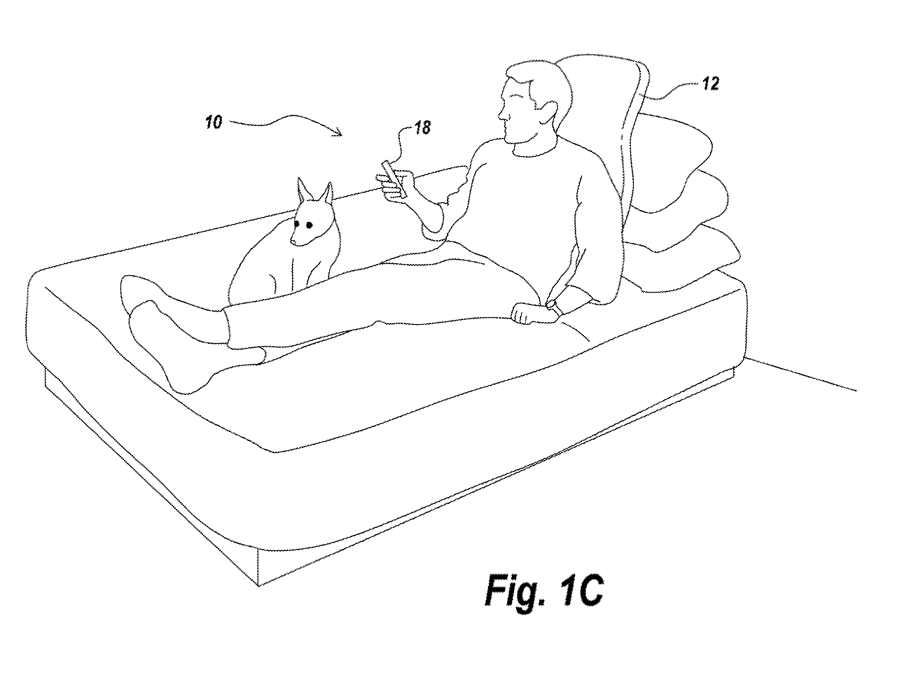

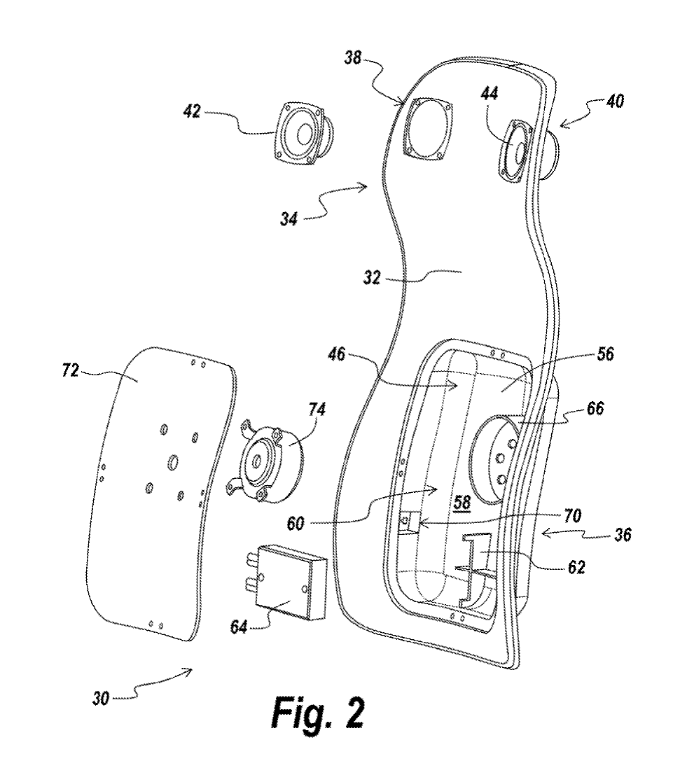

Referring now to FIGS. 2 and 3, generally designated at 30 is the vibro-acoustical chair topper with slim profile in accord with the present invention with its upholstery removed. The chair topper 30 includes an orthopedic, S-shaped, back-supporting chassis 32 adapted to be placed between the user and a seat-back. The conformal chassis 32 includes an area generally designated 34 arranged to be proximate the head of the user and an area generally designated 36 arranged to be proximate the lumbar region of the user. The chassis 32 is integrally formed of thermoplastic material to be rigid but flexible so as to be rigid enough to support the press of the human body while flexible enough to bendably conform to the seat-back of the chair on which to chair topper is placed.

Acoustic speaker compartments generally designated 38, 40 are integrally formed in the head area 34 of the thermoplastic chassis 32. Acoustic speakers 42, 44 are mounted in the acoustic speaker compartments 38, 40. As will be readily appreciated, the speakers 42, 44 mounted in the compartments 38, 40 of the head area 34 of the conformal chassis 32 provide an acoustic source to transfer acoustic energy to the ears of the user using the vibro-acoustical chair topper in accord with the present invention.

A resonating chamber generally designated 46 is integrally formed in the lumbar area 36 of the contoured chassis 32. The resonating chamber 46 includes four (4) sidewalls 48, 50, 52, 54 and included back wall 56 (best seen in FIG. 3) providing therebetween an air cavity generally designated 58. The front face generally designated 60 of the resonating chamber 46 opposite the back wall 56 thereof confronting the lumber region of the user is open.

Walls 62 integrally formed in the lumbar area 36 of the conformal chassis 32 provide an amplifier receiving compartment. A low-frequency amplifier 64 is mounted to the amplifier receiving compartment 62. The low-frequency amplifier 64 preferably provides oscillations of from ten (10) to two-hundred (200) hertz.

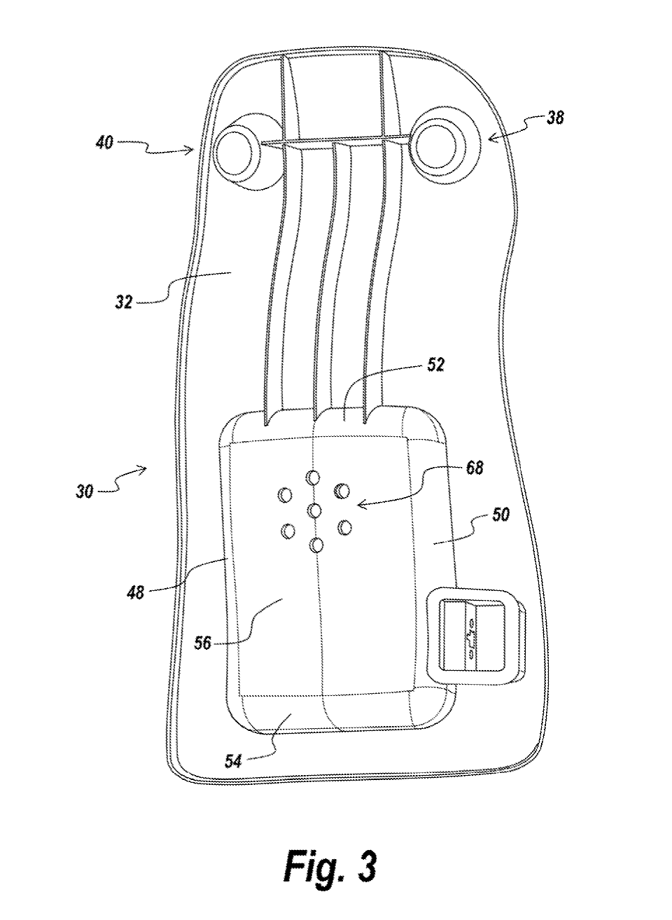

Walls 66 integrally formed in the lumbar area 36 of the conformal chassis 32 provide a low-frequency transducer receiving housing. Ports generally designated 68 (best seen in FIGS. 3, 4) are provided through the back wall 56 at the back of the transducer receiving housing 66. The ports 68 in the housing 66 attenuate low-end audio while preserving the low-frequency resonant vibrations.

Walls generally designated 70 integrally formed in the lumbar area 36 of the conformal chassis 32 provide an input/output panel. The input/output panel 70 provides jacks for a headphone, for a hand-held controller to be described and for input AC power.

A diaphragm 72 is attached to the peripheral rim of the open face 60 of the resonating chamber 46 of the conformal chassis 32. The diaphragm 72 provides a wall, substantially closing, and resonant with, the resonating chamber 46.

The diaphragm 72 is arranged as a back supporting lumbar plate sized and shaped to conform to the back and sides between the ribs and pelvis of the average user. The diaphragm 72 preferably is of a polycarbonate material harder than that of the thermoplastic material of the injection-molded conformal chassis 32 so as to both support the press of the lumbar region thereagainst and to transfer and diffuse low-frequency vibrations thereto.

A low-frequency transducer 74 is attached to the diaphragm 72. The transducer 74 has a four (4) inch diameter in the presently preferred and illustrated exemplary embodiment.

The low-frequency transducer 74 freely extends in the air cavity 58 and into the transducer receiving housing 66 of the resonating chamber 46 of the conformal chassis 32. The free extension of the transducer 74 in the air cavity 58 and into the transducer receiving housing 66 provides room for its maximum, unimpeded operational displacement.

The diaphragm 72 is generally co-extensive in size with the lumbar area of the user. The aperture size of the low-frequency transducer 74 is very much less than the area of the diaphragm 72. The low-frequency cyclic motion of the low-frequency transducer 74 sets the diaphragm 72 of the resonating chamber 46 in resonant motion as schematically illustrated by arrow 76 in FIG. 4, and thereby couples low-frequency resonant energy directly to the user, effectively diffusing it over the entire lumbar area of the user in contact therewith as schematically illustrated by arrow 78 in FIG. 4.

The resonating chamber wall dimensions and composition, air cavity dimensions, diaphragm size and composition, transducer housing size and composition and transducer size and frequency, among other parameters, may be adjusted to tune the resonance of the resonating chamber as desired.

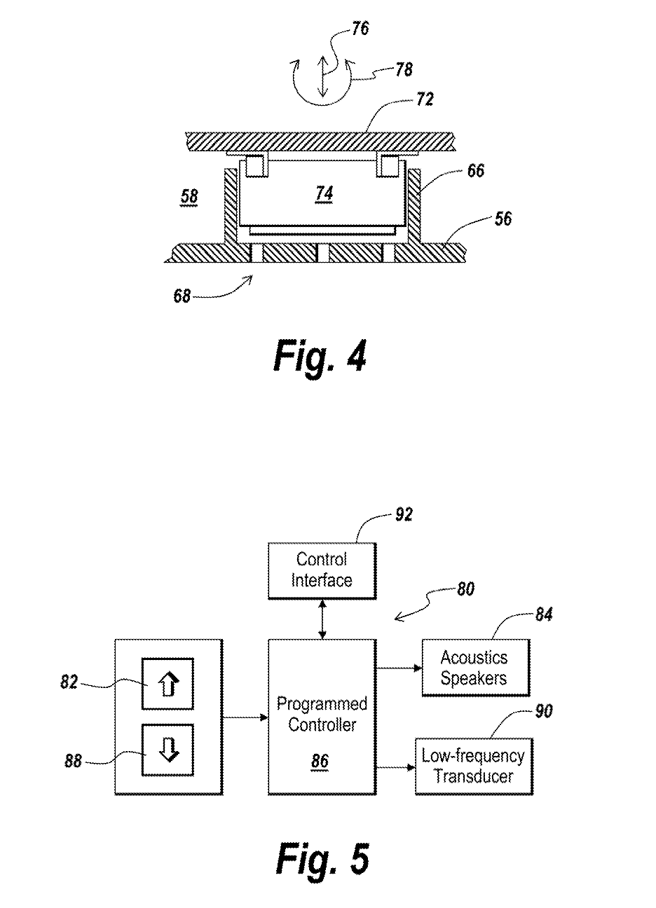

Referring now to FIG. 5, generally designated at 80 is a functional block circuit diagram of the vibro-acoustical chair topper with slim profile in accord with the present invention. As schematically illustrated by a block 82, a plurality, preferably twelve (12), prerecorded sounds in MP3 format and MP3 player are operatively connected to output audio speakers 84 via programmed controller 86. As schematically illustrated by block 88, a low-frequency amplifier driver is operatively coupled to a low-frequency transducer 90 via the programmed controller 86.

A control interface 92, connected to the controller 86, allows the user to select an audio file for play via the audio speaker(s) 84 simultaneously with a selected intensity of low-frequency vibrations provided via the low-frequency transducer 90 to provide that mode of vibro-acoustical therapy that may be of present interest to the user.

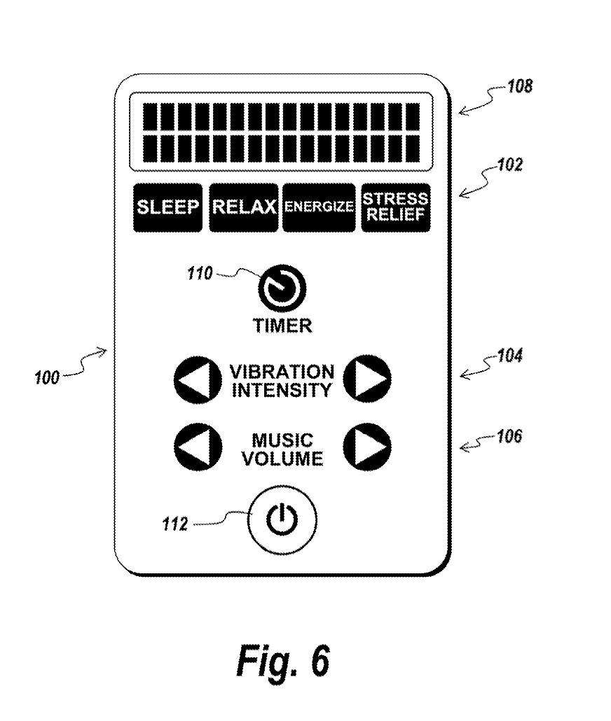

Referring now to FIG. 6, generally designated at 100 is a front view of the hand-held controller of the vibro-acoustical chair topper with slim profile in accord with the present invention. The handhold controller 100 includes a bank of audio select buttons generally designated 102. Depression of one of the buttons selects a corresponding prerecorded audio sound. The sounds preferably are grouped to provide “sleep,” “relaxation,” “energization,” and “stress relief.” Controls generally designated 104 are provided to vary the intensity of the low-frequency vibrations by depressing the corresponding increase and decrease buttons. Music volume controls generally designated 106 are provided to vary the volume of the acoustic sounds selected. The hand-held controller 100 also includes an LED area generally designated 108 which displays information representative of the vibro-acoustical mode selected. A timer button 110 and an on off switch 112 are also provided.

Many modifications of the present invention will become apparent to those of skill in the art having benefited from the instant disclosure. For example, the chamber of the low-frequency source may be wholly or partially carried by or coupled to the chassis, and the chamber of the source of low-frequency vibrational energy may be provided in a chassis having less than four walls and included back wall so long as the source of low-frequency vibrational energy includes a chamber or cavity defined by walls providing one or more recessed air cavities and at least one resonant diaphragm/transducer arranged so as to freely extend into the one or more recesses of the air cavities. The source of low-frequency vibrational energy may be employed separately from and independent of the acoustical source.

What is claimed is:

1. A vibro-acoustical body support for providing vibro-acoustical therapy to a user, comprising:
a chassis;
an acoustic source coupled to the chassis arranged to transfer acoustic energy to the ears of the user;
a source of low-frequency vibrational energy carried by the chassis arranged to transfer low-frequency vibrational energy to the body of the user;
said source of low-frequency vibrational energy includes a resonating chamber carried by the chassis, said resonating chamber carried by the chassis including an air cavity bounded by side walls and an open face confronting said user, a diaphragm attached to the open face substantially closing said resonating chamber carried by the chassis and forming a resonant wall thereof, and a low-frequency transducer attached to said diaphragm freely extending into the air cavity of and unobstructed by said walls of said resonating chamber; and
a controller coupled to said low-frequency transducer of said source of low-frequency vibrational energy that sets said diaphragm of said resonating chamber in cyclic to and fro resonant motion and thereby couples low-frequency vibrational energy directly to the user though contact with said resonant diaphragm of said resonating chamber carried by the chassis.

2. The vibro-acoustical body support for providing vibro-acoustical therapy to a user of claim 1, wherein said controller is coupled to the source of acoustic energy; and wherein said source of acoustic energy in response to user-input control selection provides audible sounds concurrently with the low-frequency vibrational energy of said source of low-frequency vibrational energy to provide different user-selectable modes of vibro-acoustical therapy.

3. The vibro-acoustical body support for providing vibro-acoustical therapy to a user of claim 1, wherein said chassis is of slim profile taller and wider than it is thick that is arranged to function as a chair topper that fits on the seat-back of a chair.

4. The vibro-acoustical body support for providing vibro-acoustical therapy to a user of claim 3, wherein said chassis is formed with an orthopedic S-shape.

5. The vibro-acoustical body support for providing vibro-acoustical therapy to a user of claim 3, wherein said diaphragm is arranged as a back supporting lumbar plate sized and shaped to conform to the back and sides between the ribs and pelvis of the user when seated on the seat-back of a chair and wherein said low-frequency transducer has an aperture size much smaller than the area of said diaphragm arranged as a back supporting lumbar plate.

6. The vibro-acoustical body support for providing vibro-acoustical therapy to a user of claim 1, wherein said low-frequency transducer has an aperture size much smaller than the area of the diaphragm so that when the diaphragm is set in resonant motion it transfers energy directly to the user over an area much larger than the aperture size of the low-frequency transducer.

7. The vibro-acoustical body support for providing vibro-acoustical therapy to a user of claim 1, wherein the sounds provided by the audio source are streamed sounds.

8. The vibro-acoustical body support for providing vibro-acoustical therapy to a user of claim 1, wherein the sounds provided by the audio source are prerecorded sounds.

9. The vibro-acoustical body support for providing vibro-acoustical therapy to a user of claim 8, wherein the prerecorded sounds provided by the audio source are provided on internal memory.

10. The vibro-acoustical body support for providing vibro-acoustical therapy to a user of claim 8, wherein the prerecorded sounds provided by the audio source are provided on external memory.

11. The vibro-acoustical body support for providing vibro-acoustical therapy to a user of claim 8, wherein the prerecorded sounds provided by the audio source are in MP3 format grouped to provide user-selectable “sleep,” “relaxation,” “energization,” and “stress relief” sounds.

12. The vibro-acoustical body support for providing vibro-acoustical therapy to a user of claim 1, wherein the controller allows the intensity of the low-frequency source to be adjusted by the user between predetermined minimum and maximum values.

13. A body support for providing kinesotherapy to a user, comprising:
a chassis including a chamber defined by walls providing an air cavity accessible through an open face;
a source of low-frequency vibrational energy carried by the chassis arranged to transfer low-frequency vibrational energy to the body of the user;
said source of low-frequency vibrational energy includes a diaphragm attached to the open face substantially closing said open face of said air cavity, and a low-frequency transducer attached to said diaphragm freely extending into the air cavity of and unobstructed by said walls of said chamber; and
a controller coupled to said low-frequency transducer of said source of low-frequency vibrational energy that sets said diaphragm of said chamber in cyclic to and fro resonant motion and thereby couples low-frequency vibrational energy directly to the user though contact with said diaphragm of said chamber of the chassis.

14. The body support for providing kinesotherapy to a user of claim 13, further including an acoustic source coupled to the chassis arranged to transfer acoustic energy to the ears of the user.
